(19) United States
(12) Patent Application Publication
(10) Pub. No.: US 2008/0318814 A1
(43) Pub. Date: Dec. 25, 2008

(54) Lubricant Oil and Lubricating Oil Additive Concentrate Compositions

(75) Inventors: Vincent J. Gatto, Baton Rouge, LA (US); Hassan Y. Elnagar, Baton Rouge, LA (US); William E. Moehle, Baton Rouge, LA (US)

Correspondence Address: ALBEMARLE CORPORATION;PATENT DEPARTMENT, 451 FLORIDA STREET, BATON ROUGE, LA, 70801, US

(73) Assignee: Albemarle Corporation, Baton Rouge, LA (US)

(21) Appl. No.: 12/160,467

(22) PCT Filed: Jan. 12, 2007
(86) PCT No.: PCT/US07/60489

§ 371 Date: Jul. 10, 2008

Related U.S. Application Data
(60) Provisional application No. 60/758,754, filed on Jan. 13, 2006.

(51) Int. Cl. C07F 5/02

(52) U.S. Cl. 508/200

(57) ABSTRACT

A lubricant oil composition having a synergistic oxidative stability is disclosed, the composition comprising at least one hindered phenolic antioxidant, at least one mono-boronated hindered phenolic antioxidant, at least one di-boronated hindered phenolic antioxidant, and at least one alkylated diphenylamine. The invention also provides a lubricating oil additive concentrate composition that imparts synergistic oxidative stability to a lubricant oil upon its addition, the concentrate composition comprising at least one hindered phenolic antioxidant, at least one mono-boronated hindered phenolic antioxidant, at least one di-boronated hindered phenolic antioxidant, and at least one alkylated diphenylamine. Further, the concentrate compositions of the present invention may also be prepared with a high concentration of hindered phenolic antioxidants without deleterious effects on viscosity or lubricant solubility.

### FIELD OF THE INVENTION

The invention relates to lubricant oil compositions and lubricating oil additive concentrate compositions. More particularly, this invention relates to combinations of hindered phenolic antioxidants, boronated hindered phenolic antioxidants, and alkylated diphenylamines useful as lubricant oil compositions and lubricating oil additive concentrate compositions.

### DESCRIPTION OF RELATED ART

Hindered phenolic and boronated hindered phenolics are well known in the art, including large molecular phenolics incorporating the moiety, 2,6-di-tert-butylphenol, and the like. See, for example, the following U.S. and foreign patents: U.S. Pat. No. 4,927,553; U.S. Pat. No. 3,356,707; U.S. Pat. No. 3,509,054; U.S. Pat. No. 3,347,793; U.S. Pat. No. 3,014,061; U.S. Pat. No. 3,359,298; U.S. Pat. No. 2,813,830; U.S. Pat. No. 2,462,616; GE 864,840; U.S. Pat. No. 5,698,499; U.S. Pat. No. 5,252,237; U.S. RE 32,295; U.S. Pat. No. 3,211,652; and U.S. Pat. No. 2,807,653.

The use of alkylated amines as an antioxidant additive in lubricating oil formulations is also well known in the art. See, for example, the following U.S. patents: U.S. Pat. No. 5,620,948; U.S. Pat. No. 5,595,964; U.S. Pat. No. 5,569,644; U.S. Pat. No. 4,857,214; U.S. Pat. No. 4,455,243; and U.S. Pat. No. 5,759,965.

### SUMMARY OF THE INVENTION

The present invention generally provides a lubricant oil composition having a synergistic oxidative stability, the composition comprising at least one hindered phenolic antioxidant, at least one mono-boronated hindered phenolic antioxidant, at least one di-boronated hindered phenolic antioxidant, and at least one alkylated diphenylamine. The invention also provides a lubricating oil additive concentrate composition that imparts synergistic oxidative stability to a lubricant oil upon its addition, the concentrate composition comprising at least one hindered phenolic antioxidant, at least one mono-boronated hindered phenolic antioxidant, at least one di-boronated hindered phenolic antioxidant, and at least one alkylated diphenylamine. Further, the concentrate compositions of the present invention may also be prepared with a high concentration of hindered phenolic antioxidants without deleterious effects on viscosity or lubricant solubility.

In one preferred embodiment, a lubricant oil or lubricating oil additive concentrate composition comprising: (a) 4,4′-methylenebis(2,6-di-tert-butylphenol), (b) 4,4′-methylenebis(2,6-di-tert-butylphenol)-mono-(di-alkyl orthoborate), (c) 4,4′-methylenebis(2,6-di-tert-butylphenol)-di-(di-alkyl orthoborate) and (d) an alkylated diphenylamine, is an effective antioxidant combination for use in lubricants.

### DETAILED DESCRIPTION OF THE INVENTION

Hindered phenolics suitable for use in the compositions of the present invention include phenolics incorporating the moieties, 2,6-di-tert-butylphenol, 2,6-di-tert-butoxyphenol, 2,6-di-tert-butyl-4-carbobutoxyphenol, and 3,5-tert-butyl-4-hydroxybenzyl pivalate, and the like. A preferred hindered phenolic, which is commercially sold by ALBEMARLE CORPORATION under the trade name ETHANOX702, is 4,4′methylenebis(2,6-di-tert-butylphenol), hereinafter referred to as MBDTBP, having the structure of Formula I below:

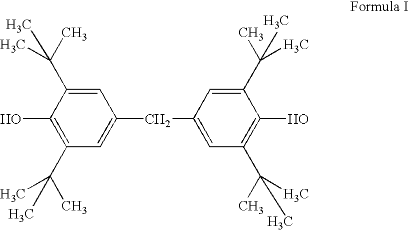

The amount of hindered phenolic present in the compositions of the invention ranges from about 1 to about 40 weight percent of the total concentration of hindered phenolic, boronated hindered phenolic, and alkylated diphenylamine.

The mono- and di-boronated hindered phenolics suitable for use in the compositions of the present invention are derived from the hindered phenolics described above by reaction with tri-alkyl orthoborates. One such process is disclosed in U.S. Pat. No. 4,927,553, which is herein incorporated by reference in its entirety. Thus preferred mono- and di-boronated hindered phenolics have the structures of Formula II and III below:

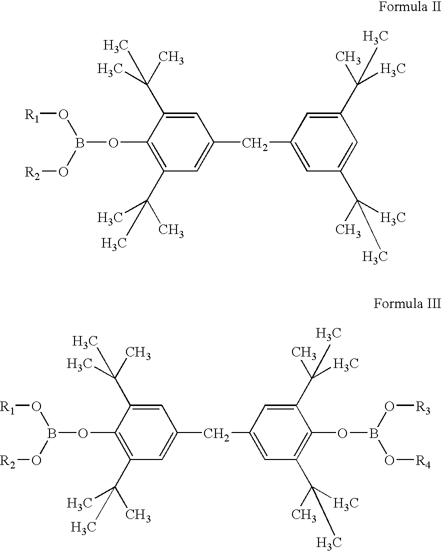

wherein R₁, R₂, R₃, and R₄ are independently selected from the group consisting of linear, branched and cyclic C₁ to C₈ alkyl groups. Examples of such groups include, but are not limited to, methyl, ethyl, n-propyl, iso-propyl, n-butyl, sec-butyl, iso-butyl, n-pentyl, 2-methylbutyl, 3-methylbutyl, 2-methyl-2-butyl, 3-methyl-2-butyl, isopentyl, n-hexyl, cyclopentyl, cyclohexyl, 2-ethylbutyl, 2-methylpentyl, 3-methylpentyl, 4-methylpentyl, 3-methyl-2-pentyl, 4-methyl-2-pentyl, 3-methyl-3-pentyl, 3,3-dimethylbutyl, 3,3-dimethyl-2-butyl, 2,3-dimethyl-2-butyl, 2-methyl-2-hexyl, 2,2-dimethyl-3-pentyl, 2-heptyl, 3-heptyl, 2-methyl-3-hexyl, 3-ethyl-3-pentyl, 2,3-dimethyl-3-pentyl, 2,4-dimethyl-3-pentyl, 5-methyl-2-hexyl, 4,4-dimethyl-2-pentyl, 5-methylhexyl, n-heptyl, n-octyl, iso-octyl, 2-ethylhexyl, 2-propylpentyl, 2-octyl, 3-octyl, 2,44-trimethylpentyl, 4-methyl-3-heptyl and 6-methyl-2-heptyl.

The combined total of mono- and di-boronated hindered phenolics present in the compositions of the invention ranges from about 10 to about 80 weight percent of the total concentration of hindered phenolic, boronated hindered phenolic, and alkylated diphenylamine. The ratio of mono-boronated hindered phenolic to di-boronated hindered phenolic may vary from about 0.01:1 to about 1:0.01. The preferred ratio ranges from about 0.8:1 to about 1:0.01, and even more preferred from about 0.8:1 to about 1:0.8.

The alkylated diphenylamines suitable for use in the compositions of the present invention are prepared from diphenylamine by reaction with olefins. One particularly useful method of preparing alkylated diphenylamines is described in U.S. patent application Ser. No. 11/442,856 (Publication No. US-2006-0276677-A1), which is incorporated in its entirety by reference herein. Both mono- and di-alkylated diphenylamines may be employed, either alone are in combination, and have the structures shown in Formula IV and V below:

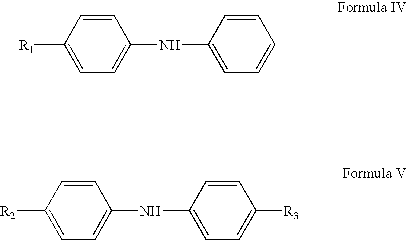

wherein R₁, R₂ and R₃ are independently selected from the group consisting of linear, branched and cyclic C₄ to C₃₂ alkyl groups. Examples of such groups include, but are not limited to, alkyl groups derived from linear alpha-olefins, isomerized alpha-olefins polymerized alpha-olefins, low molecular weight oligomers of propylene, and low molecular weight oligomers of isobutylene. Specific examples include but are not limited to butyl, pentyl, hexyl, heptyl, octyl, nonyl, decyl, undecyl, dodecyl, tridecyl, tetradecyl, dipropyl, tripropyl, tetrapropyl, pentapropyl, hexapropyl, heptapropyl, octapropyl, diisobutyl, triisobutyl, tetraisobutyl, pentaisobutyl, hexaisobutyl, and heptaisobutyl.

The combined total of mono- and di-alkylated diphenylamine present in the compositions of the invention ranges from about 10 to about 80 weight percent of the total concentration of hindered phenolic, boronated hindered phenolic, and alkylated diphenylamine. The ratio of mono- to di-alkylated diphenylamine may vary from about 0.01:1 to about 1:0.01.

Examples of preferred alkylated diphenylamines are nonylated diphenylamines (NDPA), octylated diphenylamines, mixed octylated/styrenated diphenylamines, and mixed butylated/octylated diphenylamines. Further, it is also preferred that the nitrogen content of the alkylated diphenylamines be in the range of 2.0 to 6.0 wt. %. Lower levels of nitrogen dilute the effectiveness of the alkylated diphenylamines while higher levels of nitrogen may adversely impact compatibility of the alkylated diphenylamines in the lubricant or the lubricant's volatility. It is also preferred that the alkylated diphenylamines be a liquid or low melting solid.

The lubricating oil may be any basestock or base oil (characterized as Group I, Group II, Group III, Group IV or Group V as defined by the API basestock classification system), or lubricant composed predominantly of aromatics, naphthenics, paraffinics, poly-alpha-olefins and/or synthetic esters. Further, the lubricant may also contain additional additives so as to make the system acceptable for use in a variety of applications. These additives include dispersants, detergents, viscosity index improvers, pour point depressants, anti-wear additives, extreme pressure additives, friction modifiers, corrosion inhibitors, rust inhibitors, emulsifiers, demulsifiers, anti-foaming agents, colorants, seal swelling agents, and additional antioxidants.

The present invention may be useful in passenger car engine oils, heavy duty diesel oils, medium speed diesel oils, railroad oils, marine engine oils, natural gas engine oils, 2-cycle engine oils, steam turbine oils, gas turbine oils, combined cycle turbine oils, R&O oils, industrial gear oils, automotive gear oils, compressor oils, manual transmission fluids, automatic transmission fluids, slideway oils, quench oils, flush oils and hydraulic fluids. The preferred applications are in engine oils. The most preferred application is in low phosphorus engine oils characterized by a phosphorus content of less than 1000 ppm.

The lubricating oil additive concentrate may or may not contain a diluent oil. If a diluent oil is used, the diluent oil is typically present between 1 and 80 wt. % of the concentrate.

Typically, the total amount of hindered phenolic, boronated hindered phenolic, and alkylated diphenylamine added to fully formulated oils depends upon the end use application. For example, in a turbine oil the total amount of hindered phenolic, boronated hindered phenolic, and alkylated diphenylamine added to the oil ranges between about 0.05 and about 1.0 wt. %. In contrast, in an engine oil the total amount of hindered phenolic, boronated hindered phenolic, and alkylated diphenylamine added to the oil ranges between about 0.2 and about 2.0 wt. %. In ultra-low phosphorus engine oils the total amount of hindered phenolic, boronated hindered phenolic, and alkylated diphenylamine may approach 3.0 wt. % or more.

An example of a lubricating oil additive concentrate in accordance with the present invention is as follows:
(a) 4,4-methylenebis(2,6-di-tert-butylphenol)@10 wt. %;
(b) 4,4′-methylenebis(2,6-di-tert-butylphenol) mono-(di-sec-butyl orthoborate) and 4,4′-methylenebis(2,6-di-tert-butylphenol) di-(di-sec-butyl orthoborate)@40 wt. %;
(c) dinonyldiphenylamine and monononyldiphenylamine@10 wt. %; and
(d) paraffinic diluent oil@40 wt. %.

An example of a low phosphorus engine oil in accordance with the present invention is as follows:
(a) 4,4-methylenebis(2,6-di-tert-butylphenol)@0.5 wt. %;
(b) 4,4′-methylenebis(2,6-di-tert-butylphenol) mono-(di-sec-butyl orthoborate) and 4,4′-methylenebis(2,6-di-tert-butylphenol) di-(di-sec-butyl orthoborate)@1.0 wt. %;
(c) dinonyldiphenylamine and monononyldiphenylamine@0.75 wt. %;
(d) a dispersant concentrate@4.8 wt. %;
(e) an overbased calcium detergent concentrate@1.8 wt. %;
(f) a neutral calcium detergent concentrate@0.5 wt. %;
(g) zinc dialkyldithiophosphate@0.6 weight %;
(h) a pour point depressant at 0.1 wt. %;
(i) a viscosity index improver concentrate@8.0 wt. %;
(j) an organic friction modifier@0.5 wt. %; and
(k) paraffinic lubricating oil@81.45 wt. %

### EXAMPLE 1

### Oil Thickening and Oxidation at Elevated Temperatures

A passenger car engine oil preblend was prepared in accordance with the present invention by blending the following materials:
(a) 4.92 wt. % of an ashless dispersant;
(b) 1.85 wt. % of an overbased detergent containing calcium; 0.51 wt. % of a neutral detergent containing calcium;
(c) 0.62 wt. % of a secondary zinc dialkyldithiophosphate; and
(d) 92.1 wt. % of a 150N Group II baseoil.
   To this engine oil preblend was added the components indicated in Table 1.

TABLE 1
Components of Engine Oil Examples A.1-A.5.

| Engine | | | | | | | |
|---|---|---|---|---|---|---|---|
| Oil Ex. | Example | Preblend | MBTBP | NDPA | BMDTBP | G2BO | Total |
| No. | Type | (wt %) | (wt %) | (wt %) | (wt %) | (wt %) | (wt %) |
| A.1 | Comparative | 96.00 | | 1.5 | | 2.5 | 100.00 |
| A.2 | Comparative | 96.00 | | | 2.27 | 1.73 | 100.00 |
| A.3 | Comparative | 96.00 | 1.5 | | | 2.5 | 100.00 |
| A.4 | Comparative | 96.00 | 0.75 | 0.75 | | 2.5 | 100.00 |
| A.5 | Invention | 96.00 | | 0.75 | 1.13 | 2.12 | 100.00 |

MBDTBP = 4,4′-methylenebis(2,6-di-tert-butylphenol)
BMBDTBP = boronated 4,4′-methylenebis(2,6-di-tert-butylphenol); Ratio mono- to di- = 0.85:1
NDPA = Nonylated diphenylamine
G2BO = 150N Group II baseoil

The oxidative stability of these finished engine oils was evaluated in a bulk oil oxidation test. Each oil (300 mL) was treated with an iron naphthenate oxidation catalyst to deliver 110 ppm of iron to the finished oil. The oils were heated in a block heater at 150° C., while 10 liters/hour of dry oxygen was bubbled through the oil. Samples of the oxidized oils were removed at 24, 48, 72, 96, and 100 hours. Kinematic viscosities of each sample were determined at 40° C. The percent viscosity increase of the oxidized oil versus the fresh oil was calculated. The percent viscosity increase results are shown in Table 2.

TABLE 2
Percent viscosity increase of finished oils A.1-A.5 in bulk oil
oxidation test.

| | | 0 hr | 24 hr | 48 hr | 72 hr | 96 hr | 100 hr |
|---|---|---|---|---|---|---|---|
| Comparative | A.1 | 0 | 1.9 | 57.4 | 211.2 | 514.3 | 585.2 |
| Comparative | A.2 | 0.0 | 3.0 | 8.9 | 74.0 | 266.9 | 330.9 |
| Comparative | A.3 | 0.0 | 34.4 | 199.6 | 576.7 | TVTM | TVTM |
| Comparative | A.4 | 0.0 | 0.6 | 69.5 | 249.4 | 671.4 | 776.7 |
| Invention | A.5 | 0.0 | 1.3 | 2.8 | 3.9 | 4.7 | 5.3 |

TVTM: too viscous to measure

A higher percent viscosity increase is a measure of increased oxidation and degradation of the lubricant. The designation TVTM is an indication of severe degradation of the lubricant. These results clearly show that the antioxidant combination of the present invention in Example A.5 provides superior oxidation protection compared to the other Examples (A.1-A.4). Antioxidant systems that do not contain the combination of 4,4′-methylenebis(2,6-di-tert-butylphenol), boronated 4,4′-methylenebis(2,6-di-tert-butylphenol) and nonylated diphenylamine show poor oxidation control while systems containing BMDTBP and NDPA show superior oxidative control.

### EXAMPLE 2

### Thermo-Oxidation Engine Oil Simulation Test, TEOST MHT-4 (ASTM D-7907)

Passenger car engine oils A1 thru A5 of Example 1 were evaluated for deposit forming tendencies in the Thermo-Oxidation Engine Oil Simulation Test, TEOST MHT-4. The test was performed according to ASTM D-7907 and manufacturer recommendations. In the TEOST test, fresh passenger car motor oil is introduced to a heated wire-wound depositor rod through an oil feed tube. A thin film of oil moves evenly down the rod and is collected at the oil flow out point. Recovered oil is circulated back to the depositor rod via a precision pump. At the end of the test, the depositor rod assembly is dismantled and deposits are determined by the increase in depositor rod weight and reported in milligrams (mg). High levels of deposits arc an indication of poor oxidation protection in the test lubricant. Alternatively, very low levels of deposits indicate good oxidation protection in the test lubricant. The deposit results are shown in Table 3.

TABLE 3
TEOST Deposits for finished oils A.1-A.5.

| | | Deposits (mg) | Deposits (mg) |
|---|---|---|---|
| | ID | Run #1 | Run #2 |
| Comparative | A.1 | 49.3 | 49.9 |
| Comparative | A.2 | 65.8 | 78.1 |
| Comparative | A.3 | 26.0 | |
| Comparative | A.4 | 13.6 | |
| Invention | A.5 | 47.6 | 38.5 |

TVTM: too viscous to measure

Note that engine oil A.4 containing NDPA and MBDTBP provided excellent deposit control results in the TEOST MHT-4. However, this same oil gave very poor viscosity control in the oil thickening test at elevated temperature. Alternatively, the combination of boronated compound BMBDTBP and NDPA in inventive example A.5 gave a moderate level of deposits but excellent viscosity control in the oil thickening test at elevated temperature. The BMBDTBP sample used in inventive example A.5 contained 4.7 wt. % of 4,4′-methylenebis(2,6-di-tert-butylphenol). Thus, for effective control of oil thickening at elevated temperature, and deposit control in the TEOST MHT-4 test, it is desirable to have an engine oil containing MBDTBP, BMBDTBP, and NDPA. For improved deposit control, it is preferred to maximize the level of MBDTBP and NDPA. Alternatively, for improved oil thickening control, it is preferred to maximize the level of BMBDTBP and NDPA.

While the compositions and methods of this invention have been described in terms of preferred embodiments, it will be apparent to those of skill in the art that variations may be applied to the compositions, methods and/or processes and in the steps or in the sequence of steps of the methods described herein without departing from the concept and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the scope and concept of the invention.

1-40. (canceled)

41. A lubricant oil composition comprising at least one hindered phenolic antioxidant, at least one boronated hindered phenolic antioxidant, and at least one alkylated diphenylamine.

42. The lubricant oil composition of claim 41, wherein the at least one boronated hindered phenolic antioxidant is derived from the at least one hindered phenolic antioxidant.

42. The lubricant oil composition of claim 42, wherein the at least one boronated hindered phenolic antioxidant comprises mono- and di-boronated hindered phenolic antioxidant.

43. The lubricant oil composition of claim 43, wherein the hindered phenolic antioxidant is 4,4′-methylenebis(2,6-di-tert-butylphenol).

44. The lubricant oil composition of claim 44, wherein the mono-boronated hindered phenolic antioxidant has the structure 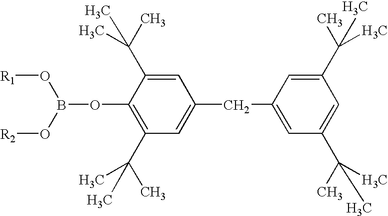
and the di-boronated hindered phenolic antioxidant has the structure 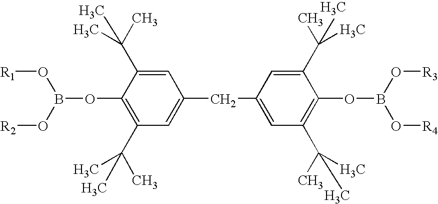
wherein R₁, R₂, R₃, and R₄ are independently selected from the group consisting of linear, branched and cyclic C₁ to C₈ alkyl groups.

45. The lubricant oil composition of claim 45, wherein the at least one alkylated diphenylamine comprises mono- and di-alkylated diphenylamine.

46. The lubricant oil composition of claim 46, wherein the mono-alkylated diphenylamine has the structure 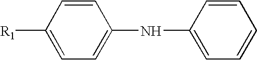
and the di-alkylated diphenylamine has the structure 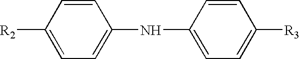
wherein R₁, R₂ and R₃ are independently selected from the group consisting of linear, branched and cyclic C₄ to C₃₂ alkyl groups.

47. The lubricant oil composition of claim 47, wherein the mono- and di-alkylated diphenylamine is selected from the group consisting of nonylated diphenylamines, octylated diphenylamines, a mixture of octylated diphenylamines and styrenated diphenylamines, and a mixture of butylated diphenylamines and octylated diphenylamines.

48. The lubricant oil composition of claim 47, wherein the concentration of 4,4′-methylenebis(2,6-di-tert-butylphenol) is between about 1 to about 40 weight percent of the total concentration of hindered phenolic, boronated hindered phenolic, and alkylated diphenylamine.

50. The lubricant oil composition of claim 49, wherein the concentration of mono- and di-boronated hindered phenolic is between about 10 to about 80 weight percent of the total concentration of hindered phenolic, boronated hindered phenolic, and alkylated diphenylamine.

51. The lubricant oil composition of claim 50, wherein the ratio of mono-boronated hindered phenolic to di-boronated hindered phenolic is between about 1:1 to about 1:0.01.

52. The lubricant oil composition of claim 51, wherein the concentration of alkylated diphenylamine is between about 10 to about 80 weight percent of the total concentration of hindered phenolic, boronated hindered phenolic, and alkylated diphenylamine.

53. The lubricant oil composition of claim 52, further comprising a diluent oil.

54. The lubricant oil composition of claim 53, wherein the concentration of the diluent oil is between about 1 to about 80 wt %.

55. The lubricant oil composition according to any of claims 41 or 53 further comprising at least one basestock or base oil.

56. The lubricant oil composition of claim 55, wherein the lubricant oil composition is used to lubricate an engine selected from the group consisting of a gasoline engine, a heavy duty diesel engine, a natural gas engine, a marine engine and a railroad engine.
